(19) United States
(12) Patent Application Publication
(10) Pub. No.: US 2010/0315035 A1
(43) Pub. Date: Dec. 16, 2010

(54) Autonomous Module with Extended Operational Life and Method Fabrication the Same

(75) Inventors: Nickolai S. Belov, Los Gatos, CA (US); Victor A. Lifton, Bridgewater, NJ (US)

Correspondence Address: Nickolai S Belov, 118 Plazoleta, Los Gatos, CA, 95032, US

(73) Assignees: Nickolai S. Belov, Los Gatos, CA (US); Victor A. Lifton, Bridgewater, NJ (US)

(21) Appl. No.: 12/796,671

(22) Filed: Jun. 9, 2010

Related U.S. Application Data
(60) Provisional application No. 61/268,449, filed on Jun. 13, 2009.

(51) Int. Cl. H01M 10/46

(52) U.S. Cl. 320/101

(57) ABSTRACT

An autonomous power module is a module that supplies electrical power to the electronic devices or systems it is designed to power. It consists of a battery module, energy harvesting module and controller module. The purpose of the autonomous power module is to provide means of supplying electrical power to the electronic devices for prolonged periods of time.

### RELATED APPLICATIONS

This application claims the benefit of U.S. provisional application 61/268,449, filed on Jun. 13, 2009.

### FIELD OF THE INVENTION

This invention is related to systems and methods of providing power to the electronic devices and systems capable of functioning autonomously for long periods of time when replacement and/or maintenance of energy storage devices is not practical, impossible or ineffective.

### SUMMARY OF THE INVENTION

An autonomous power module is a module that supplies electrical power to the electronic devices and systems it is designed to power for an extended period of time.

An autonomous power module contains a battery module, an energy harvesting module and a controller module.

The battery module contains at least one energy storage component from the group of storage components consisting of: (a) a primary battery; (b) a rechargeable battery; (c) a reserve battery along or in any combination with a) through c). Moreover, each type of batteries (primary, rechargeable or reserve) may include sub-sets of batteries with various combinations of electrodes (anode and cathode) and the electrolyte suitable for optimal performance under different conditions (environmental conditions, maximum current, and duty cycle).

The energy harvesting module contains at least one energy harvesting device. Energy harvesting devices of the following types can be employed: (a) photovoltaic devices, including solar cells, transforming energy of solar radiation into electrical energy; (b) piezoelectric devices transforming energy of mechanical deformation into electrical energy; (c) magneto-electric devices transforming energy of magnetic field into electrical energy; (d) mechano-electric devices transforming mechanical energy of motion/vibrations into electrical energy; (e) thermo-electric devices transforming thermal energy into electrical energy; (f) radio wave devices transforming energy of electromagnetic radio waves into electrical energy; and (g) radioactive sources transforming energy of nuclear reactions into electrical energy. Any combination of energy harvesting devices of the same or different types can be used in the autonomous power module. The energy harvesting module also can contain a battery charging circuitry to maintain proper levels of charge and/or discharge of the electrochemical energy storage devices such as primary, rechargeable and reserve batteries, extending and maintaining their useful operational life. The module has appropriate circuitry to be able to detect and report its state of health and performance and to autonomously and/or by request perform self-test.

The controller module contains at least one sensing component, at least one switch and a controller module.

The sensing components can sense/measure at least one of the following parameters: (a) state of charge of at least one component of the battery module; (b) temperature; (c) current consumption by the electronic device or system served by the power module; (d) time. The sensing components can detect other parameters of both the environment and the module itself.

The switch allows for at least one type of switching selected from the group of: (a) switching between different sources of energy available within the battery module to power the electronic device or system served by the power module; (b) connecting output of an energy harvesting device with a rechargeable battery via the battery charging circuitry, and (c) disconnecting energy harvesting device and a rechargeable battery.

The controller module performs analysis of the operating conditions (environmental conditions and duty cycle) and decides which type of batteries (primary, rechargeable or reserve) is better suited for providing power to the electronic devices and/or systems. The controller module is capable of making decisions regarding: (a) type of battery and chemistry (anode, cathode, electrolyte) that is better suited for a given power needs and (b) state of at least some switches based on the signals provided by the sensing components. This data can be used by the controller to assure that charge and discharge of the electrochemical energy storage devices occur during the periods when the conditions are appropriate, thus helping to extend and maintain their useful operational life.

The batteries, other parts of the power module and the electronic devices can be covered with at least one layer of water-repelling coating (also known as hydrophobic, superhydrophobic, superlyophobic, superoleophobic, ultraphobic). The purpose of such layers is to prevent moisture/water accumulation on the surface of the module and its components and to prevent moisture/water penetration inside the module. In addition, such coatings may prevent corrosion and damage from the chemicals contained in the environment. They may also prevent unwanted galvanic and electrochemical reactions between the materials comprising the power module and/or with the environment. The coatings may consist of several layers of varying thickness and/or different materials. Such structure prevents damage to electronic components and energy storage devices contained within the module. This allows for autonomous module operation for extended periods of time, typically exceeding 10 years and potentially as long as 25-40 years.

To increase reliability and operational life time of the power module electrical connections are made using solder or welding techniques.

### BRIEF DESCRIPTION OF DRAWINGS

FIG. 1 shows a block diagram of the power module consisting of the battery module, energy harvesting module and controller/logic module.

FIG. 2 shows a block diagram of the battery module that includes primary, rechargeable and reserve batteries. Each battery type may consist of various sub-cells that are specifically designed for operating under certain conditions.

FIG. 3 shows a block diagram of a battery pack coated with coatings of various compositions, properties and thicknesses.

FIG. 4 shows that each component of the power module may have its own protective layers to prevent moisture and oxygen permeation.

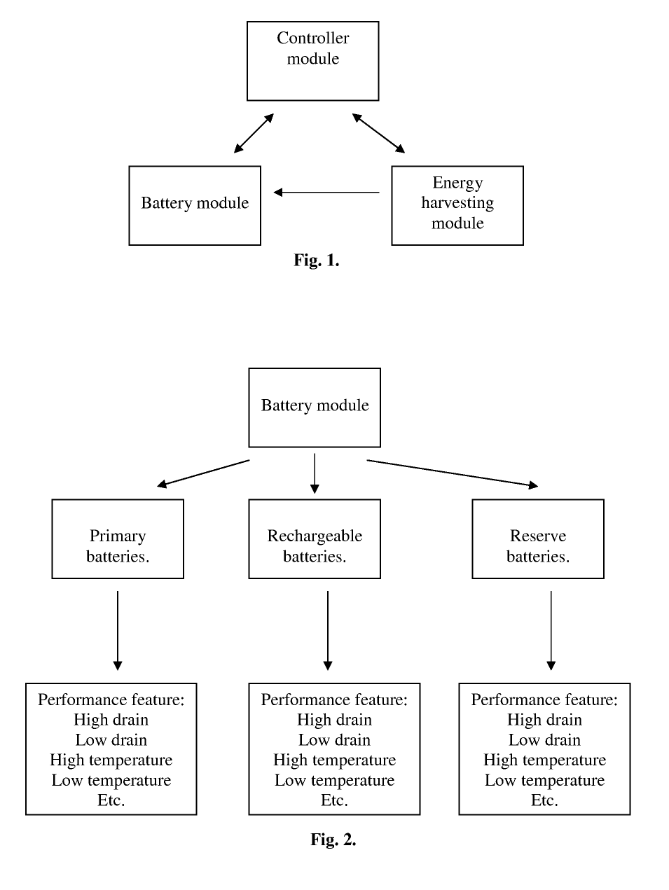

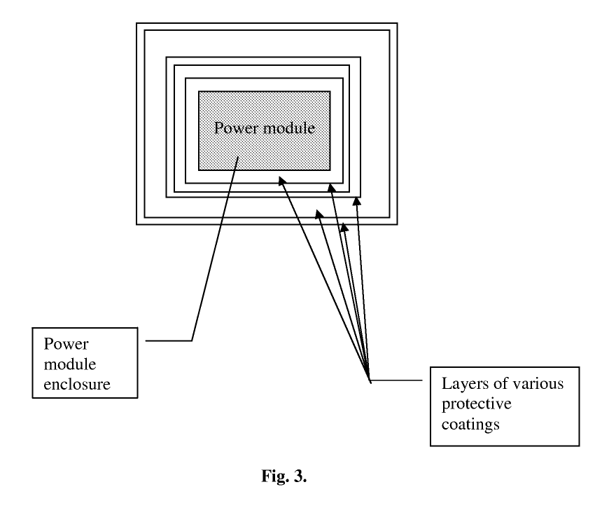

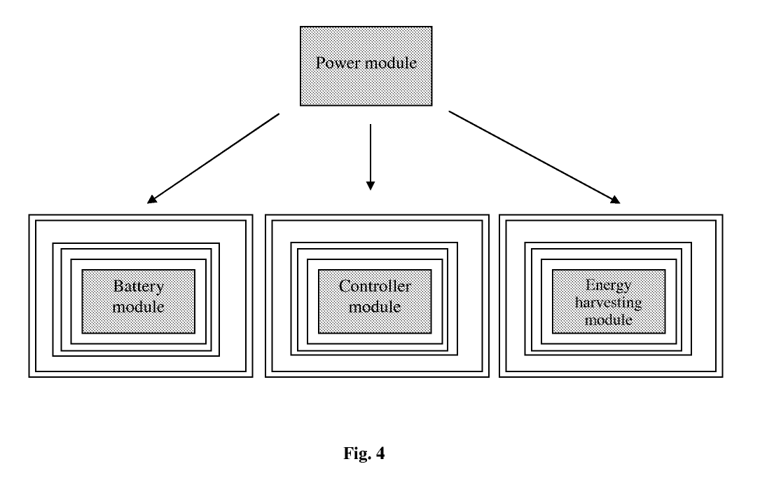

### DETAILED DESCRIPTION

Energy Storage and Controller Module

Energy can be stored in the form of chemical energy within the so called electrochemical batteries. Batteries can be classified as primary (single use), secondary (rechargeable) and reserve (back up). In the present invention any combination of primary, rechargeable and reserve batteries may be coupled with an energy harvesting device.

Many different types of batteries are produced by a multitude of manufacturers. Batteries differ by the type of chemistry (combination of electrode materials and electrolyte contained within). This allows for building batteries that are better suited to providing power under different conditions. For example, some batteries can be designed to deliver low current pulses for long periods of time (slow drain, low self discharge), other types can be better suited for providing short current pulses at high value of current (high drain, higher self discharge). In other situations certain types of batteries are better suited for working under high temperature, while others perform better at low temperature. Sometimes batteries can be combined with other components. For example, combination of a low-current battery and a super-capacitor can have advantages of both low self discharge and ability to provide high current pulses.

In the present invention, various types of batteries can be contained within the same physical enclosure thus providing a choice of various battery characteristics. In particular, autonomous power module can contain at least one primary battery pack; at least one rechargeable battery pack; at least one reserve battery pack; at least one rechargeable and at least one primary battery pack; at least one rechargeable and at least one reserve battery pack; at least one primary and at least one reserve battery pack; at least one primary, at least one rechargeable and at least one reserve battery pack and combination of the above.

In order to provide power over a wide range of operating and environmental conditions at least one battery pack can contain more than one type of batteries. For example, batteries having different material of electrodes, different electrolytes or different ranges of operating conditions can be used within one pack.

The controller module monitors the environmental conditions (e.g. temperature), load (current draw) conditions, battery state-of-charge or state-of-discharge and based on such information decides which type of batteries is better suited for providing power to the system. Data about environmental conditions, current consumption, battery state of charge, time and other parameters can be provided by sensing components, which are part of the power module. Switching between different batteries as power sources for the electronics is executed by at least one switch controlled by the controller module.

Different sensing components or sensors can be integrated into the autonomous module. In particular, “fuel gauges” sensing state of charge of at least one component of the battery module, temperature sensor, current consumption sensing component, clock can combination of these sensing components can be used in the autonomous modules.

When it comes to rechargeable batteries they also differ amongst themselves by the depth of discharge they can sustain without undergoing a permanent damage, capacity loss and/or cycling capacity and temperature range where the battery can be effectively used and charged.

Rechargeable batteries typically have both limited range of operating temperatures and limited range of temperatures within which they can be charged. For example, it is not recommended to use most of rechargeable batteries at temperatures below —20° C. while temperatures above 60° C. can damage them. These factors can put significant limitations on the use battery modules containing only rechargeable batteries. Super-capacitors have a much wider operating temperature range. However, currently they have limited capacity, which can be significantly smaller than the capacity of a rechargeable battery. Therefore, energy stored in super-capacitors can support electronic device for a much shorter time than the time it can be supported by a rechargeable battery and a reduced energy supply can result in either failure or hibernation of the electronic device if it relies on super-capacitors as a sole energy storage components. Therefore, a combination of energy storage devices such as batteries and super-capacitors can be advantageous in some applications where electronic devices can be for a short time exposed to temperatures outside the operating temperature range of the rechargeable battery.

Therefore, the controller module monitors the environmental conditions (e.g. temperature), load conditions (current draw) and the present state of the rechargeable batteries (depth of discharge and depth of charge) and decides which type of batteries is better suited for providing power to the electronic devices and/or systems and which type of batteries is better suited for charging using energy harvested by the energy harvesting devices. Switching again is performed by at least one switch controlled by the controller module.

Reserve batteries are provisioned in the power module as a backup power source that can be activated if and when other batteries fail or drop below the minimum required capacity. Under normal conditions, the reserve batteries are sitting idle, without losing their capacity and do not deliver power to the system.

The controller module may use only one type of the batteries available in the power module (for example, only primary or only rechargeable). It may use a combination of batteries (for example, primary and rechargeable, rechargeable and energy harvesting).

The controller module also decides which type of rechargeable batteries should be recharged under a given set of conditions (state of discharge, environmental conditions and power draw conditions). In case if other rechargeable sources of energy are used, for example, super-capacitors in combination with primary batteries then they also can be recharged with help of the energy harvesting device. The controller module makes decisions regarding priorities of charging of rechargeable components. Switches controlled by controller are used to connect output of energy harvesting device and one of the rechargeable components. Typically an intermediate battery charging circuit is used to condition output voltage/current of the energy harvesting device to a form suitable for charging a secondary battery or other rechargeable component.

The autonomous module can be connected to a wireless link and some data provided by the sensing components as well as some results of data processing can be transmitted through the wireless link. This information can be used by users or owners of the autonomous module to evaluate its condition and remaining service life of batteries as well as detect failures of some components.

Energy Harvesting Elements

Harvesting energy from different ambient sources can be used, including solar radiation, mechanical energy of vibration, wind energy, thermal energy, energy of electromagnetic waves in RF range, energy of radioactive particles and others. Not all of these sources have the same potential for energy harvesting when the 1-10 mW range of harvested power is targeted for many years of autonomous work. In some cases energy harvesting device should provide average power of about 10 mW. For some systems a smaller amount of harvested energy (having an order of magnitude of 1 mW) can be sufficient.

Even small size solar panels are capable of providing this average level of power during a day. However, in some applications photovoltaic elements (or a transparent protective cover for the elements) can be contaminated over time decreasing the amount of harvested energy. In other applications solar energy can be unavailable at the locations where the device is installed (e.g. inside a tunnel, inside a building etc.) or due to geographical location (e.g. dark polar night). Besides that, some applications may require that the electronic devices and their power modules to be installed in places not exposed to direct sunlight or even in dark places. Therefore, solar energy harvester may be less attractive for some applications where the electronic device/system should work autonomously for many years. There are options of using such element outdoors if natural “cleaning” due to rain and wind is sufficient to keep the element effective for a very long period of time.

Harvesting mechanical energy is also an option. A piezoelectric wind harvester working in bending mode can be an attractive option. This type of energy harvesting device can work for a very long time. It can be designed to be protected from large deflections, which can cause plastic deformation or other damage of mechanical parts by a strong wind or mechanical contact between parts of the energy harvesting device and a foreign object. Such devices are available on the market. For example, Advanced Cerametrics Incorporated manufactures energy harvesting devices utilizing piezoelectric fibers having extremely long life time (“forever”, according to the company). The piezoelectric harvesters utilize PZT for energy harvesting, providing a high voltage suitable for use in battery charging. Intermediate voltage conditioning circuit is typically needed for piezoelectric energy harvesters. Devices having output corresponding to tens of milli-Watts of continuous power are available.

Energy harvesting from devices having a vibrating mass is also possible. Vibration harvesters can be more effective if the object of monitoring experienced vibrations with frequencies above 10 Hz and, preferably, above 100 Hz because energy that can be harvested from vibrations rapidly increases with increase of frequency of vibrations. However, harvesting about 10 mW power from low frequency oscillations may require use of a relatively large mass (0.1-1.0 kg), which can be undesirable for some applications.

Thermoelectric harvesting using Seebeck effect potentially can be used in some applications. However, the Seebeck coefficient for most of materials suitable for thermoelectric harvesting is in the order of 0.2-0.3 mV/K. Taking into account that temperature difference at the working setup of the power module is likely to be less than 10 K, one can conclude that thousands of thermocouples should be combined in order to obtain voltages suitable for charging a battery. Therefore, suitable applications should be identified based on a potential for a large temperature gradient within the area where the monitoring device can be installed.

Radioactive energy sources also can be used as part of the energy harvesting elements of the power module.

If the energy harvesting device can be located inside the package of the power module—this can be achieved in case of solar panel (the package can have a transparent window for the solar panel), vibration, thermoelectric harvesting devices and radioactive energy source then the package of the power module allows for excellent protection of the energy harvesting device/source of energy.

In some cases the power module can be electrically connected to an existing energy harvesting device, as for example an existing solar panel. In such case there may be no need for an additional energy harvesting device within the power module. In some cases it can be advantageous to separate the energy harvesting device and the power module in order to get both more energy and better protection for the module. For example, the power module can be protected from direct sunlight and corresponding heating while the energy harvesting device can be installed in open sun.

Energy harvesting module may contain a rechargeable battery within itself that will in turn recharge a rechargeable battery that is part of the power module.

Battery charging circuitry can be used to condition output voltage or current of the energy harvesting module and supply this conditioned voltage or current to the battery module. Battery charging circuitry can include a set of functional units providing such functions as AC-DC conversion, DC-DC conversion, battery voltage overload protection, ESD protection, accumulating energy in at least one reactive energy storage component, filtering, voltage stabilization, switching and combination of the above.

Power module can be connected to a power line and secondary batteries can be recharged from an AC or DC source.

Protective Coatings and Assembly Considerations

The purpose of the protective coatings is to prevent moisture accumulation and penetration into sensitive electronic devices and circuitry contained within the power module and/or overall system. The main function of the coating is to prevent water (moisture) from wetting the surface of the device. In addition, thick coatings significantly increase the diffusion distance for the water molecules before they can reach the electrical contacts and cause failure (corrosion, parasitic electrical connections, etc.)

The coatings may also prevent oxygen (contained in the air) and other chemicals from reaching and chemically reacting with (oxidizing and corroding) the parts contained within the power module and/or overall system.

The coating stack may consist of more then one coating. Each coating may have different chemical and mechanical properties. Thickness of each coating may also be different. Some coatings may be applied in several steps to increase thickness and/or improve their performance characteristics.

Some coatings may have hydrophobic (water-repelling) properties.

Some coatings may have special additives mix into them. For example, they may contain nanoparticles mixed into them to make more chemically resistant or increase their hydrophobic properties. Other materials may include so called getters, the materials specifically designed to absorb and/or neutralize oxygen, moisture and other reactive gases.

The arrangement of the coatings may alternate and various combinations of coatings and fillers may be used in a stack of coatings.

Some coatings may contain so called phase change materials. Such materials may undergo phase transformation at a certain temperature with the absorption of heat in the process. This may lead to a reduction of temperature inside the power module and/or overall system, which may lead to an increase in the operational life of the power module and/or overall system by preventing overheating.

Some coatings or all of them can be conformally deposited over all of the components of the power module and/or overall system.

Some coatings may contain porosity which may lead to a reduced heat transfer through the coatings keeping the power module and/or overall system from overheating. The porous layer may be treated with the conformal hydrophobic (water-repellent) coating to prevent moisture condensation inside the pores.

Some coatings may have special materials (such as heat sensitive pigments) in them that change color at various temperatures. This allow for identification of temperature inside of the power module and/or overall system.

The assembled battery packs and the coatings may be placed inside a rigid enclosure to protect them from damage and improve handling. The enclosure may be hermetically or near-hermetically sealed to prevent any moisture and gases from getting inside. Packaging of the power module can be done in inert atmosphere, and the getters and the substances absorbing/adsorbing moisture can be added inside the enclosure.

Besides that, all electrical connections within the power module are, preferably, made using soldering and/or welding and protected by at least one layer of coating providing a barrier for moisture and oxygen.

Self-Test and Module Health Monitoring

Controller may periodically and/or on demand perform module self-test to determine the state of health (charge, number of recharge cycles, etc.) of the power source.

The power module can be either equipped with or connected to a wireless sensor that periodically and/or on demand sends updates regarding the state of health (charge, number of recharge cycles, etc.) of the power source.

The description has not attempted to exhaustively enumerate all possible variations nor embodiments. Alternative embodiments are possible as other devices can be fabricated with the described approaches and methods. It will be appreciated that other embodiments are within the invention scope of the following claims.

We claim:

1. A power module to supply power to electronic devices comprising:
at least one battery;
at least one energy harvesting device harvesting energy from ambient and converting it into electrical energy;
a battery charging circuitry using the electrical energy generated by at least one energy harvesting device to charge at least one battery
wherein in order to achieve long operation life time the power module is chemically and mechanically protected by a set of protective means selected from the group of: environmentally protective coating covering at least some portions of the power module; placing of at least one battery and a battery charging circuitry in an enclosure; placing energy harvesting device in an enclosure; mechanical protection for components of energy harvesting device from mechanical overloading, placing water- and oxygen-absorbing and adsorbing materials inside the enclosure; filling the enclosure with inert gases and combination of the above.

2. A power module according to claim 1 wherein in order to provide a very long service life of the power module and uninterrupted supply of power at least one battery is chosen from the set of batteries consisting of:
at least one primary battery pack;
at least one rechargeable battery pack;
at least one reserve battery pack;
at least one rechargeable and at least one primary battery pack;
at least one rechargeable and at least one reserve battery pack;
at least one primary and at least one reserve battery pack;
at least one primary, at least one rechargeable and at least one reserve battery pack and combination of the above.

3. A power module according to claim 2 wherein in order to provide power over a wide range of operating and environmental conditions at least one battery pack consists of more than one battery and chosen from a group of battery packs consisting of:
at least two batteries having different material of electrodes;
at least two batteries having different electrolytes;
at least two batteries having different ranges of operating and environmental conditions and combination of the above.

4. A power module according to claim 1 wherein the energy harvesting device uses an energy transformation selected from the following list of energy transformations: energy of magnetic field to electrical energy, mechanical energy to electrical energy, energy of elastic deformation to electrical energy, energy of wind to electrical energy, energy of radiation to electrical energy, thermal energy to electrical energy, energy of electromagnetic waves to electrical energy, energy of a radioactive particles to electrical energy, and chemical energy to electrical energy and combination of the above.

5. A power module according to claim 1 wherein the battery charging circuitry includes a set of functional units providing at least some functions selected from the following set of functions: AC-DC conversion, DC-DC conversion, battery voltage overload protection, ESD protection, accumulating energy in at least one reactive energy storage component, filtering, voltage stabilization, switching and combination of the above.

6. A power module according to claim 1 wherein the environmental protective coatings are chosen from a group of coatings consisting of: water repellent coating, oxygen absorbing coating, a coating having a porosity, a coating containing a phase change material, a coating containing a heat-sensitive pigment, a stack of coatings having different water-repelling properties, a stack of coatings having different thickness, and combination of the above.

7. A power module according to claim 1 wherein for the purpose of better protection of at least one battery and battery charging circuitry the enclosure has at least near hermetic sealing.

8. A power module according to claim 1 further comprising a self test module; the self test module performs self-tests of the power module to determine the state of health of the components of the power module.

9. A power module to supply power to electronic devices comprising:
at least one battery;
at least one energy harvesting device harvesting energy from ambient and transferring it into electrical energy;
a battery charging circuitry using the electrical energy generated by the at least one energy harvesting device to charge the at least one battery; and
a set of sensors for measuring environmental parameters,
wherein the measurement data provided by the set of sensors are used to control the battery usage in order to optimize the battery performance.

10. A power module according to claim 9 wherein the power module is connected to a wireless link and at least some data provided by the set of sensors is transmitted through the wireless link.

11. A power module according to claim 9 wherein the energy harvesting device captures the energy from the ambient sources consisting of: temperature gradients, pressure variation, wind, solar energy, light, radioactive decay, sound, electromagnetic radiation, and mechanical vibrations and converts it to electrical energy.

12. A power module according to claim 9 wherein the energy harvested by the energy harvesting device is used to charge at least one rechargeable battery.

13. A power module to supply power to electronic devices comprising:
at least one battery;
at least one energy harvesting device harvesting energy from ambient and transferring it into electrical energy;
a battery charging circuitry using the electrical energy generated by the at least one energy harvesting device to charge the at least one battery;
a set of sensors for measuring environmental parameters; and
a controller module;
wherein the controller module controls the battery charging circuitry using measurement data provided by the set of sensors.

14. A power module of claim 13 wherein the set of sensors further comprises sensors of at least one parameter chosen from the group of: a battery capacity, a battery status, a battery depth of discharge, battery temperature, battery output current, power module output current, time.

15. A power module according to claim 13 comprising more than one battery wherein the controller module provides a function selected from the set of functions: monitoring the conditions of the environment and the status of the batteries using data provided by the set of sensors; control of which battery pack delivers power to the electronic device; control of which rechargeable battery is charged under given operating and environmental conditions and combination of the above.

16. A method of supplying power to electronic devices comprising the steps of:
providing at least one battery;
providing at least one energy harvesting device for harvesting energy from ambient and converting it into electrical energy;
providing a battery charging circuitry for charging of at least one battery by using the electrical energy generated by the at least one energy harvesting device;
assembling a power module by placing at least one battery and the battery charging circuitry into an enclosure and connecting the battery charging circuitry with the energy harvesting device and with at least one battery;
using said power module to supply power to electronic devices,
wherein in order to achieve long operation life time of the power module its components are protected mechanically and chemically using steps chosen from the set of steps consisting of: adding oxygen absorbing materials inside the enclosure; adding water adsorbing materials inside the enclosure; using hermetic sealing of the enclosure; using near-hermetic sealing of the enclosure; filling the enclosure with inert gases; covering at least some portions of the power module with environmentally protective coatings chosen from a group of coatings consisting of: water repellent coating, oxygen absorbing coating, a coating having a porosity, a coating containing a phase change material, a coating containing a heat-sensitive pigment, a stack of coatings having different water-repelling properties, a stack of coatings having different thickness, and combination of the above.
